(19) United States
(12) Patent Application Publication
(10) Pub. No.: US 2002/0023271 A1
(43) Pub. Date: Feb. 21, 2002

(54) System and method for enhanced navigation

(76) Inventors: Joseph E. Augenbraun, Princeton, NJ (US); Gerard K. Kunkel, Yardley, PA (US); Michael Mathiesen, Yardley, PA (US); Kitsel Outlaw, Landsdale, PA (US); Scott A. Piette, New Hope, PA (US); Randell E. Jesup, Downington, PA (US); Malia C. Flynn, Philadelphia, PA (US); Richard W. Westerfer JR., Lower Gwynedd, PA (US); Richard L. Booth, Bensalem, PA (US); Philip M. Faustine, Lansdale, PA (US)

Correspondence Address: William A. Blake, Jones, Tullar & Cooper, P.C., P.O. Box 2266 Eads Station, Arlington, VA, 22202, US

(21) Appl. No.: 09/736,392

(22) Filed: Dec. 15, 2000

Related U.S. Application Data
(60) Provisional application No. 60/170,791, filed on Dec. 15, 1999.
(60) Provisional application No. 60/202,849, filed on May 8, 2000.

(51) Int. Cl. H04N 7/173

(52) U.S. Cl. 725/109

(57) ABSTRACT

Navigation techniques enable Internet web pages and other image frames to be navigated using a conventional keyboard or a television remote control, for example. In a first technique, a guide mapping application links objects in the various frames contained in an accessed web page so that when a user actuates a directional button on a remote control or a keyboard, the guide mapping application navigates the user to an object in the present frame or in another frame to which a currently selected object is linked. The guide mapping application also employs “edge of frame” indicators in those objects which are located on an edge of a frame. When an “edge of frame” indicator is detected, the application searches for and locates the appropriate adjacent frame, as well as the object within the adjacent frame that is located in the closest proximity to the object containing the “edge of frame” indicator, and then navigates the user to that object. A navigation application is also preferably provided that detects when a user actuates a specified key or combination of keys, or holds down a specified key for a fixed period of time, for example, and changes the functionality of the key or keys from cursor navigation to mouse navigation to enable the user to navigate a web page as if they had a mouse input device.

### PRIORITY CLAIM UNDER 35 USC 119(e)

This application claims the benefit, under 35 U.S.C. 119(e), of U.S. Provisional Application No. 60/170,791, filed Dec. 15, 1999, and U.S. Provisional Application No. 60/202,849, filed May 8, 2000.

### BACKGROUND OF THE INVENTION

1. Field of the Invention

The present invention relates generally to a system and method for navigating through information displayed on a monitor using a directional control device, such as a keyboard or a television remote control.

2. Description of the Background Art

In today's market, advances in technology have allowed television viewers to access several interactive services over their television sets. Such interactive services, include, for example, Internet and e-mail over TV services, such as those provided by WorldGate Communications as described in U.S. Pat. Nos. 5,631,603, 5,999,970, and 6,049,539, all of which are incorporated herein by reference; video-on-demand services; interactive program guides; and pay per view programming.

As is well known, the “Internet” is a world-wide interconnected network of computers which provides users with access to a tremendous volume of information on practically any topic one can imagine. The information accessed by a user typically consists of web pages, which may consist of one or more frames. Each frame of a web page may contain multiple objects which perform particular functions when navigated to and selected. In order to navigate through the various frames and objects displayed on a screen, many of today's computer systems are equipped with mouse type devices which allow a user to move a pointer, typically an arrow, across the various frames of a web page to the desired object and to select the object to activate the associated function. This is commonly referred to as the “point and click” method.

A mouse type device, however, may not always be available for use. This can occur, for instance, if the system does not supply a mouse type device, the mouse type device is not functioning or has been disabled. More importantly, with the ever increasing use of interactive television, where users can have full interactive access to the Internet through a television set, a mouse or such similar device can be cumbersome and otherwise unworkable. However, without the use of such a device, a user must scroll through entire displays of information using only the arrow keys provided on a keyboard or television remote control. As a result, navigating through web pages and frames on a web page has proved particularly problematic in an interactive television system.

This difficulty has led some interactive television providers to eliminate frames from web pages. In such a situation, an entire web page is displayed as one frame that a user can navigate by using the directional control arrows on a keyboard or television remote control device. One shortcoming of such a method is that objects that a user has become accustomed to easily accessing, such as menu options to move back to a previous page or to copy particular portions of a web page, are scrolled out of the view of the user as the user navigates throughout the web page. This forces the user to scroll to the top, or bottom as the case may be, of the web page in order to gain access to such customary functions.

### SUMMARY OF THE INVENTION

The present invention solves the foregoing and other problems by providing a number of techniques that enhance a user's ability to navigate web pages and other image frames using a conventional remote control device or a keyboard. In a first technique, a guide mapping application is provided that is interfaced to an image generator, such as a browser application. The mapping application employs guide maps that preferably consist of objects and links which link objects in the various frames contained in an accessed web page, and thereby control the objects to which a user may navigate. In this manner, when a user actuates a directional button on a remote control or a keyboard, for example, the guide mapping program navigates the user to an object in the present frame or in another frame to which a currently highlighted or selected object is linked.

The guide mapping application also preferably permits navigation between frames of a web page by employing “edge of frame” indicators in those objects which are located on an edge of a frame. When the user actuates a directional key, for example, and an “edge of frame” indicator is detected, the application searches for and locates the appropriate adjacent frame, as well as the object within the adjacent frame that is located in the closest proximity to the object containing the “edge of frame” indicator. The image generator or browser application then highlights that object so that the user may select it through actuation of an enter key, or the like.

In another embodiment of the invention, the functionality of the keys on a remote control device or a keyboard is transformed from cursor functionality to mouse functionality so that a user can navigate among objects on a page using specified keys, such as the directional keys, for example, to move a cursor to a desired object, and then select the object using the enter key, for example. To accomplish this, a navigation application is provided for converting inputs from a keyboard or remote control, for example, into mouse-type inputs in which one or more keys or buttons can be used to move a mouse prompt and then select an object on which the prompt is located. Mouse functionality is selected by the user in any convenient manner, such as by actuation of a designated key or combination of keys, or actuation of a key (a directional arrow key, for example) for a fixed period of time (e.g. 1 second). When this occurs, the navigation application changes the operation of the directional keys from cursor navigation to mouse navigation. In this manner, a highlighted object or cursor transforms into a mouse prompt and the user is able to move the mouse prompt in any direction by utilizing the directional arrow keys on their remote control device or keyboard, and then select an object by “clicking” on it with an enter key, or the like.

In the foregoing manner, the guide mapping and navigation applications of the present invention allow a user to navigate quickly anD efficiently between navigable objects and frames displayed on a screen by using a directional control device, such as the arrow keys on a standard keyboard or television remote control.

### BRIEF DESCRIPTION OF THE DRAWINGS

The features and advantages of the present invention will become apparent from the following detailed description of a number of preferred embodiments thereof, taken in conjunction with the accompanying drawings, in which:

FIG. 1 is a block diagram of an exemplary CATV system with which the concepts of the present invention may be employed;

FIGS. 2A, 2B and 2C are schematic illustrations of Internet web pages that can be navigated using the concepts of the present invention; and

FIG. 3 is a flow chart illustrating the steps carried out in a preferred embodiment of the invention for navigating between frames on a multiple frame web page using an edge of frame detection technique.

### DETAILED DESCRIPTION OF THE PREFERRED EMBODIMENTS

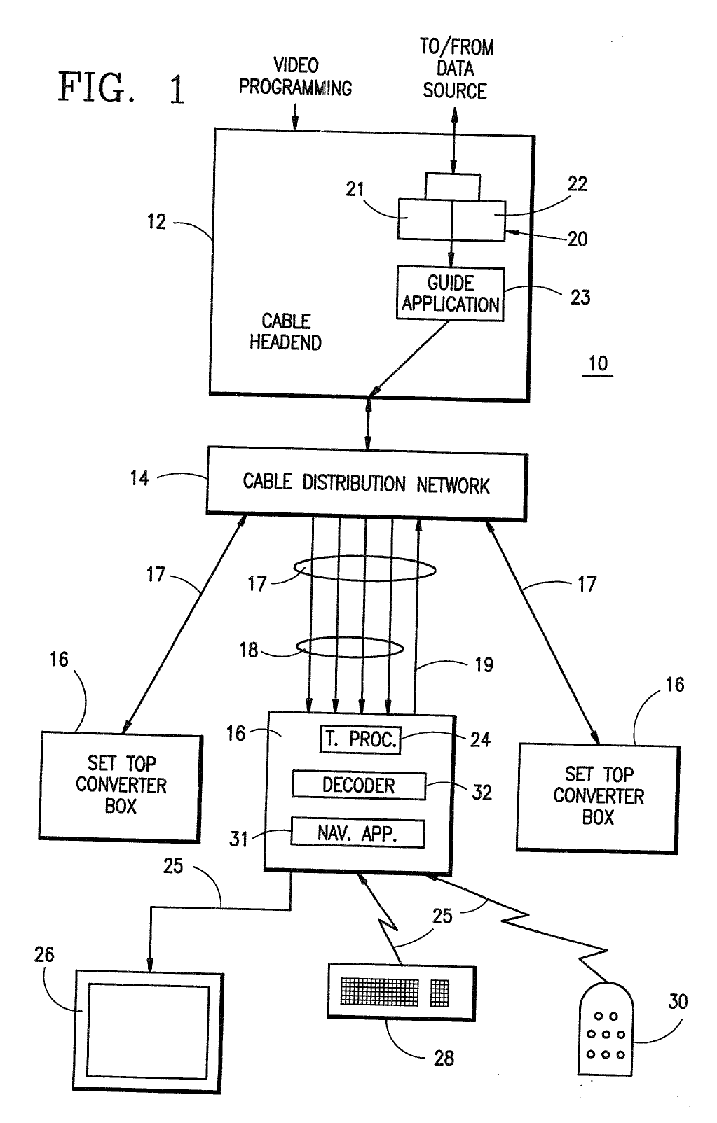

FIG. 1 is a general block diagram of a CATV system 10 which incorporates elements for facilitating access to the Internet by a plurality of system users, and is illustrative of one type of system with which the concepts of the present invention may be employed. It should be noted that the CATV system 10 is illustrated in general form since many of its detailed elements are not necessary for an understanding of the present invention. It will also be understood that the present invention is not limited to use with CATV systems, and can be employed in any type of data processing system, such as a network, personal computer or a hand-held data device.

The CATV system 10 includes a cable headend 12 and a cable television distribution network 14 for interfacing the headend 12 to a plurality of set top converter boxes 16. A plurality of bi-directional transmission links 17 interconnects the set top converter boxes 16 with the distribution network 14, each of which includes a plurality of downstream channels 18 and one or more upstream channels 19. For clarity, the details of only one of the set top boxes 16 and associated elements are illustrated in FIG. 1.

The cable headend 12 receives video programming and Internet-based information from remote sources (not shown), and transmits the video programming and other information through the distribution network 14 to the set top boxes 16. Typically, the video programming is received from the remote source in either an analog format, or a digitally compressed or encoded format, such as MPEG 1 or MPEG 2. The Internet-based information, on the other hand, is typically HTML coded web pages along with still or moving images coded in JPEG, GIF, PNG, etc. formats which are employed by one or more image generators, such as browser application 20 to generate web page bit map images. As is conventional, the browser application 20 includes an associated memory 21 and a processing controller 22. A directional guide mapping application 23, which may be a mesh application, for example, is also provided in the headend 12 and interfaces with the processing controller 22 of the browser application 20. The guide mapping application 23 generates a directional guide map consisting of links and objects of frames that are distributed through the distribution network 14 to the set top boxes 16. The directional guide mapping application 23 is employed to produce an easy means to navigate through the web pages retrieved by the browser application 20. The results of the directional guide maps are stored in the memory 21 of the browser application 20.

Each of the set top boxes 16 is interfaced via a terminal processor 24 and associated communication links 25 (e.g., cables, infrared wireless links, etc.) to a television or monitor 26, and one or more input devices, such as a wireless keyboard 28 and a remote control 30. The set top box 16 also contains a navigation application 31 which interfaces with the terminal processor 24 to control navigation through the displayed information and to transform the navigator into mouse functionality as will be discussed in greater detail. As each set top box 16 receives the digitally (e.g., MPEG) encoded or compressed video programming and Internet-based information from the distribution network 14, it is passed through a decoder 32 which restores the video programming signals and web page image data to their original form for display on the television or monitor 26.

The CATV system 10 thus allows a system user to conduct an Internet session by sending appropriate commands via the keyboard 28 and/or remote control 30 to the headend 12. In response, the headend 12 connects the user to one of the browser applications 20, and retrieves the requested Internet information from the remote source. The visual information generated by the browser application 20 is mapped by the mapping application 23 and downloaded to the user's set top box 16 for display on their television or monitor 26. In the example of the system 10 of FIG. 1, when a user navigates to objects within a frame using either the keyboard 28 or the remote control 30, the navigation commands are sent to the browser application 20 which performs the actual navigation by using the guide maps generated by the mapping application 23. Alternatively, the present system may store the guide maps, or portions thereof, and the controlling means locally (e.g., in the set top box 16) to enhance navigation and to reduce required communication with the headend 12. In this alternative embodiment, all navigation would be performed in the set top box 16, and communication with the headend 12 would be limited to activation of a highlighted object or attempts to navigate outside the stored map or maps.

Preferably, as the browser application 20 retrieves a web page from the Internet, the guide mapping application 23 interfaces with the browser application 20 to build a guide map for each frame of the web page, and the guide maps are then stored in the memory 21 of the browser application 20. Alternatively, and in order to conserve memory, a guide map may be generated for each frame of a web page only when a user navigates to that particular frame. Guide maps consist of nodes (also referred to as objects) and links which control the objects to which a user may navigate. A guide map only permits navigation to objects to which the current object is connected via a link. While the present invention may be described in terms of utilizing maps or meshes, it will be understood that the present invention is not limited to navigating with maps or meshes, and other guide mapping technology may be employed. In addition, the node to be navigated to may alternatively be determined at the time that the user requests the navigation to save processing time. This navigation information may also be cached for later reuse. It will further be understood that the present invention is not limited to map guides generated for frames, but rather the present invention can involve map guides of other subsets of a web page, for example, the portion within the viewing area and those portions outside the present viewing area.

As will be shown, the preferred embodiment of the present invention permits all navigable objects displayed on a screen to be navigated to by pressing a specific key or combination of keys on a standard keyboard 28 or a remote control device 30. Preferably, the specific keys bear some logical relationship to the desired task, such as the right arrow key when pressed will navigate to the object to the right of the current object; the left arrow key when pressed will navigate to the object to the left of the current object; the up arrow key will navigate to the object above the current object; and the down arrow key will navigate to the object below the current object. It will be understood by those of ordinary skill in the art that any key or combination of keys may be used to navigate in a certain manner.

Upon initiation of an Internet session, a user retrieves a first web page from the Internet. Preferably, the first object of the first frame of the initial web page of each Internet session is highlighted when displayed on the screen so that the user visually is made aware of its current position. In the preferred embodiment, polygonal objects are highlighted. While no vertices limit exists for highlighting purposes, an aggregate byte count limit for the entire screen may be implemented and must be taken into consideration.

The method of highlighting an object may take many forms, including, but not limited to drawing a dark border around the object, placing an image overlaying the object, shading the object, or changing the color of the object. The method of highlighting an object on a screen is well known in the art, and will not be discussed in detail herein. It also will be understood by those skilled in the art that highlighting an object is not limited to a visual display, but highlighting may also include playing of audio signals or messages, or a combination of visual and audio signals or messages.

To activate a highlighted object, the user presses a specified activation key, such as the enter or select key, to execute the particular application associated with that object. To view another object, a user presses the appropriate directional key (e.g., the right arrow key) to navigate to an object located to the particular direction of the currently highlighted object.

In the preferred embodiment, a user is also permitted to navigate more quickly to any object by transforming the keyboard 28 or the remote control 30 into a mouse device. This is accomplished by the user actuating a specified key or combination of keys, or by holding down a specified key or combination of keys (a directional arrow key, for example) for a fixed period of time (e.g. 1 second). When a directional key command is detected as being pressed down for the predetermined time, the navigation application 31 changes the operation of the directional keys from cursor navigation to mouse navigation, and sends mouse prompt movement commands to the browser processing controller 22. In this manner, the highlighted object or cursor transforms into a mouse prompt and the user is able to move the mouse prompt in any direction by utilizing the directional arrow keys on the keyboard 28 or the remote control 30, for example. It will be understood that the transformation into the mouse navigation is not limited to the down press of a key for a predetermined time period, but rather, the transformation may occur on the up stroke (or release) of a key after a designated time, or by pressing a separate button on the keyboard 28 or the remote control 30 which is dedicated to toggling between the mouse navigation and the cursor navigation may be pressed.

When a directional key command is detected, the browser processing controller 22 references the guide map to determine if a link and object are located in the direction of the command. If a link and object in the command direction are detected, the processing controller 22 navigates to and highlights the object. In the event a link and object in the command direction are not located, the current objects remains highlighted until the user selects that object, navigates in a direction containing a link and object, or is attempting to navigate between frames, which will be discussed in more detail below.

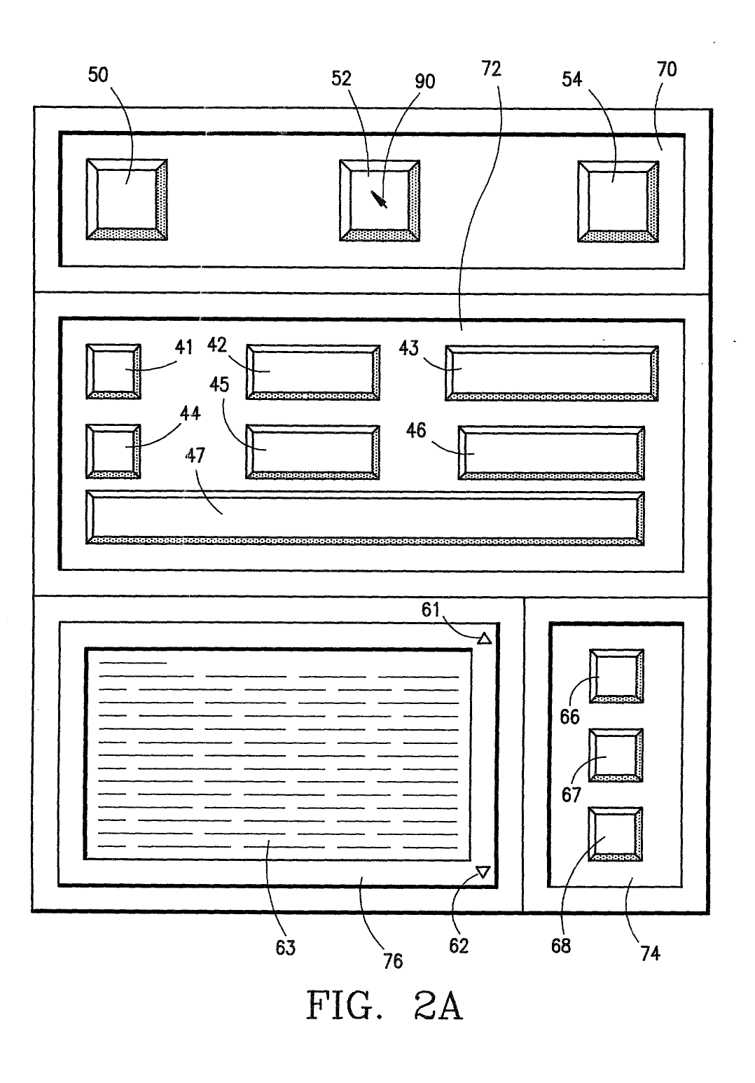

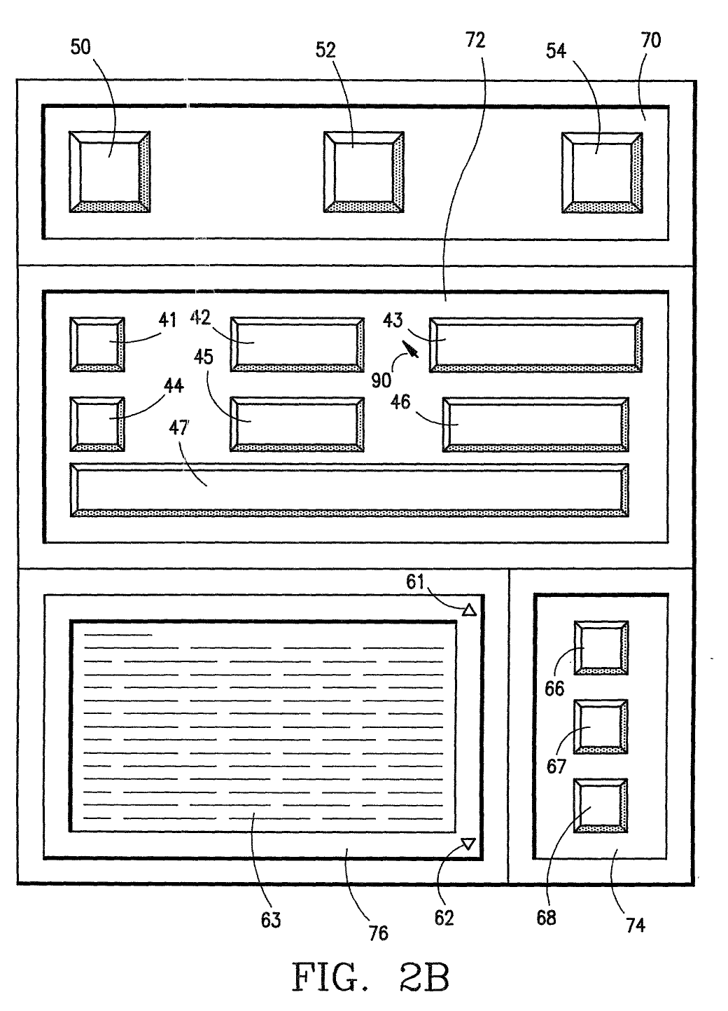

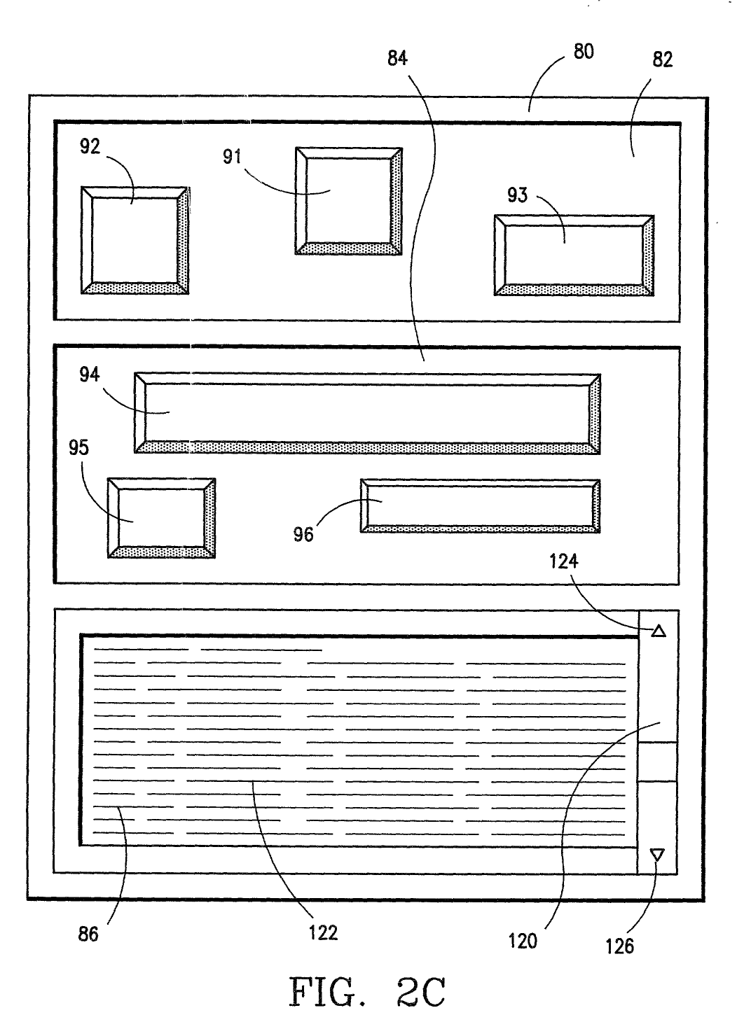

Referring to FIG. 2A, a web page is depicted which shows a plurality of objects 41, 42, 43, 44, 45, 46, 47, 50, 52, 54, 66, 67 and 68, a pair of arrows 61 and 62 on a cursor bar, and a plurality of frames 70, 72, 74, 76. Such objects may include boxes, radio buttons, push buttons, links to other web pages or files, scroll bars and advertisements. The results of selecting an object may include, but are not limited to, connecting to a linked web site, starting an application program, viewing a previous web page, or even scrolling vertically or horizontally by way of scroll bars through the displayed information.

In the present invention, a user may navigate, for example, from the highlighted object 52 to another object 42 by holding down the down arrow key on the keyboard 28 or the remote control 30. The signal from the keyboard 28 or the remote control 30 is detected by the navigation application 31. If the navigation application 31 detects that the down arrow key remains pressed for a predetermined period of time, the navigation application 31 causes a mouse prompt 90 (e.g. an arrow) to be displayed on the screen on the highlighted object 52. In this mode, a user is able to move the mouse prompt 90 in any direction throughout the displayed screen by utilizing the arrow keys on the keyboard 28 or the remote control 30. For example, the user may navigate to the object 42 either by pressing the down arrow key, or move directly to object 46 by pressing the appropriate down arrow and right keys on the keyboard 28 or the remote control 30.

When a user wishes to select a particular object the user may navigate to that object and press the appropriate select button on the keyboard 28 or the remote control 30. Referring again to FIG. 2A, if the user wishes to navigate from the object 52 to the object 42, the user would press the appropriate arrow key (e.g. down arrow key) to move the mouse prompt 90 to that object. When a select button is detected, the browser processing controller 22 references the guide map to determine the location of the mouse prompt 90. If the mouse prompt 90 is located on an object, the appropriate action for that object occurs.

Preferably, if the mouse prompt 90 is not located on an object, the processing controller 22 will locate the nearest object and highlight and select that object when the appropriate select key is detected. As previously discussed, this occurs by the navigation application 31 referencing the guide map and determining the closest object. Referring to FIG. 2B, a web page is depicted with the mouse prompt 90 being located between the objects 42 and 43. When the navigation application 31 detects a select signal, the navigation application 31 sends the coordinates of the mouse prompt 90's location to the guide mapping application 23, which references the guide map to determine the nearest object. In FIG. 2B, the object 43 would be highlighted and selected because the object 43 is the object closest to the mouse prompt 90.

The user is also able to toggle between mouse functionality and cursor functionality in the present invention. Preferably, when the user is in the mouse functionality mode, the navigation application 31 will transform the mouse prompt 90 back into the cursor functionality after detecting no key presses for a predetermined period of time (e.g. 1 second). When this occurs, the closest object to the mouse prompt 90 is highlighted, in the same manner as previously discussed when the select button is pressed and the mouse prompt 90 is not on an object.

Preferably, the present invention also allows the user to switch between different remote control or input devices to navigate through displayed information. Preferably, when the navigation application 31 is in mouse prompt functionality, a user may utilize a different remote control device before the time out period, and the new input device will continue to operate with the same mouse prompt functionality. Alternatively, the present invention may exit the mouse functionality mode if a new input or remote control device is detected.

In the preferred embodiment, flags are also inserted on all objects which are located on the edge of a frame. As will be shown, this allows a user to navigate between frames on the screen. The flags indicate which edge or edges of the frame a particular object borders. The guide map provides for flags which indicate that an object is a “top edge object”, a “bottom edge object”, a “right edge object” or a “left edge object”, or some combination thereof. Referring again to FIG. 2A, the object 41 of the frame 72, for example, would contain a “left edge object” flag and a “top edge object” flag because it borders both the left and top edges of the frame 72. Similarly, the object 46 contains only a “right edge object” flag because it borders only the right edge of the frame 72. As should be obvious, the object 45 does not have an edge of frame flag because it does not border any edge of the frame 72.

To enhance the user's ability to maintain track of the user's location, as successive web pages are retrieved, the system preferably highlights an object in a similar location on the new web page as was highlighted on the previous web page. This is accomplished through the browser memory 21, which retains the guide map for the previous page to enable determination of the location of the last highlighted object of the previous web page. Referring to FIGS. 2A and 2C, assume a user is currently viewing the web page displayed in FIG. 2A and the object 42 of the frame 72 is currently highlighted. If the user now selects to view the application associated with the object 42, an associated web page 80 is displayed, as illustrated in FIG. 2C. The mapping application 23 compares the guide map for the previously highlighted frame with the various guide maps of the newly retrieved web page 80 and highlights an object that is located in a similar position to that of the object 42 in the previous web page. In this instance, for example, an object 94 would be highlighted upon retrieval of the new web page 80.

It will be understood that navigation in the present invention is not limited to one direction. For instance, a user is able to navigate to a previous object by pressing the opposite arrow key. Again with reference to FIG. 2A, if a user has navigated within the frame 72 from the object 41 to the object 42 by pressing the right arrow key, the user may navigate back to the object 41 simply by pressing the left arrow key. Further, while the present invention has been described by navigating horizontally within a frame, a user may also navigate vertically by pressing the up or down arrow keys. For example and again referring to FIG. 2A, if the object 42 of the frame 72 is highlighted, a user may navigate to the object 45 by pressing the down arrow key.

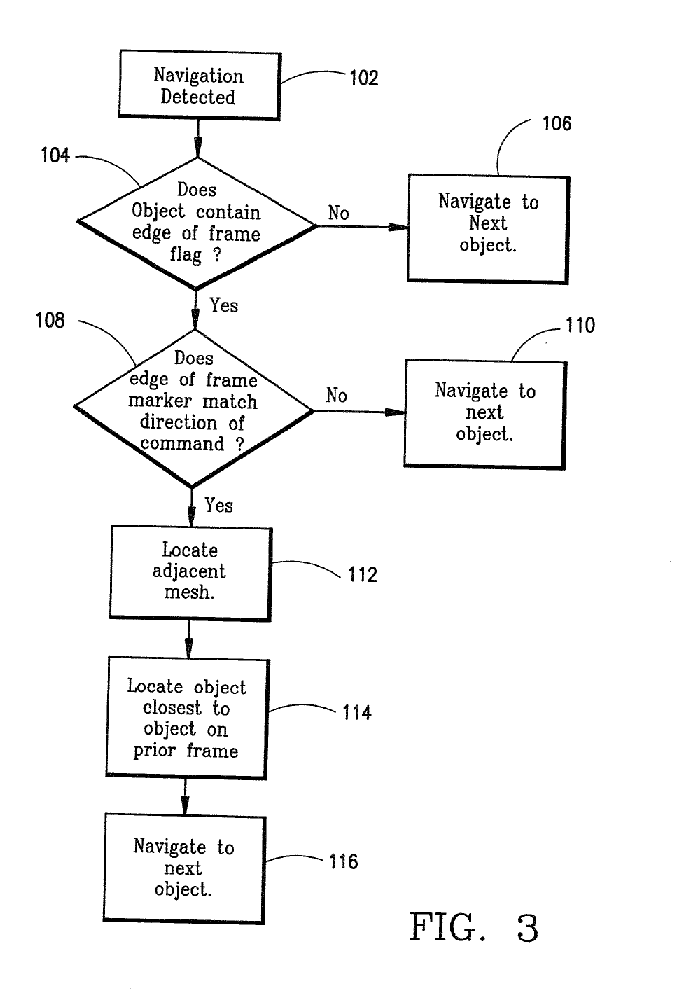

As previously discussed, the present invention also allows a user to navigate through multiple frames on a web page by utilizing edge of frame flags. When a user desires to navigate to another frame, the user must first navigate to an object which contains an edge of frame flag. Referring to the flow chart of FIG. 3, upon receipt of a command indicating that navigation has been detected at step 102, the browser processing controller 22 determines whether the object contains an edge of frame flag at step 104. If not, the processing controller 22 navigates to the next object at step 106. On the other hand, in the event the guide map indicates that the object currently highlighted is an edge of frame object, the processing controller 22 determines whether the edge of frame flag matches the direction command at step 108. If the edge of frame marker does not match the direction command, the processing controller 22 navigates to and highlights the next object at step 110. If the edge of frame flag matches the direction command, the processing controller 22 searches the remaining stored guide maps to locate the guide map adjacent to the map with the currently highlighted object at step 112. The determination to match guide maps may be based on a number of criteria. Preferably, the processing controller 22 searches the guide maps to determine the next frame based on a comparison of the geometry of the two frames, such that the two guide maps are a geometrical match. Alternatively, the guide maps may be linked in a specific order such that a frame guide map exists for each web page. Once the proper matching frame is located, the processing controller 22, at step 114, next locates the object in the new frame located closest to the highlighted object in the prior frame. Once located, the processing controller 22 navigates to and highlights that object at step 116, in the manner previously discussed.

Th foregoing process may be illustrated by example with reference again to FIG. 2A. If the object 43 is currently highlighted and the user desires to navigate to the object 54, which is located in the frame 70, by pressing the up arrow key, the processing controller 22 detects an edge of top frame flag for the object 43, and searches for the appropriate frame above the current frame 72. The processing controller 22 determines that the frame 70 is the appropriate frame. The processing controller 22 then searches within the frame 70 to determine the object located in the closest proximity to the object 43 in the frame 72. The processing controller 22 would determine that the object 54 in the frame 70 is located closest to the object 43 in the frame 72, and the processing controller 22 would then navigate to and highlight the object 54 of the frame 70.

In an alternative embodiment of the present invention, frame navigation may be limited to specific objects. For example, the processing controller 22 may limit frame navigation to the horizontal arrow keys. In this alternative embodiment, navigation between frames would occur only by first navigating to the frame's upper left most object to navigate to a frame above or to the left of the current frame, or to its lowest right most object to navigate to a screen below or to the right of the current frame. In this alternative embodiment, and with reference again to FIG. 2C, in order to navigate from the frame 82 to the frame 84, the user would be required to first navigate to the object 93 in the frame 82, and then press the right arrow key to navigate to the frame 84. This action would then highlight the object 94 in the frame 84. In yet a further alternative embodiment, when a user attempts to navigate from one frame to another, the present invention may first require the edge of a frame to be displayed in the viewing area prior to navigating to the next frame. This alternative embodiment is particularly prevalent where the guide maps are categorized by guide maps currently displayed within the viewable area, and those guide maps that are outside the viewing area.

The present invention can, alternatively, treat scroll bars as navigable objects. Scroll bars are well known in the art, and need not be discussed in detail herein. Upon retrieval of a web page, the guide mapping application recognizes scroll bars, both vertical and horizontal, and designates the arrows of the scroll bars as navigable objects. As is well known, scroll bars may be employed to scroll through various matters, such as particular information within a frame, such as text; an entire frame; or even an entire displayed screen. Preferably, the arrows of a scroll bar are associated with particular objects. For example, in the employment of a vertical scroll bar associated with an entire frame, the up arrow would be associated with the top object contained in the frame. Likewise, the down arrow of the scroll bar would be associated with the lowest object contained in the frame. It will be understood that the present invention does not require the presence of scroll bars and is not limited to treating scroll bars as navigable objects. Rather, the present invention functions regardless of whether scroll bars are treated as navigable objects.

The user may navigate between the arrows of a scroll bar by selecting the proper corresponding arrow key on the keyboard or remote control device. For example, and with reference to FIG. 2C, a scroll bar 120 associated with text information 122 is illustrated. The up arrow 124 and the down arrow 126 are employed as navigable objects. If the up arrow 124 of the scroll bar 120 is highlighted, the user may navigate to the down arrow 126 of the scroll bar 120 by pressing the down arrow key, as previously described.

Being navigable objects, the arrows 124 and 126 of the scroll bar 120 may also be activated like any other object. When an arrow of a scroll bar is navigated to and highlighted, the user in the preferred embodiment may select the arrow by pressing the appropriate select button, as previously discussed. When an arrow in a scroll bar is selected, the user is able to scroll through information associated with the scroll bar in the direction of the activated arrow of the scroll bar by pressing an appropriate key on the keyboard or remote controls, such as the select button or an arrow key. Again referring to FIG. 2C, when a user activates the down arrow 126 of the scroll bar 120, the user scrolls down the text information 122 by pressing either a select button or the down arrow key on the keyboard. Preferably, the scrolling of the text will occur on a line by line basis, but it should be understood that pressing the select button on the down arrow 126 of the scroll bar 120 may scroll the viewable text in some other fixed manner. For example, it is well known that scrolling can occur by page, by a certain number of lines, or by some other determined amount. While the preferred embodiment has been described with reference to vertical scroll bars, it will be understood by those skilled in the art that the processing controller 22 will work as described with horizontal scroll bars or other scroll bars. As such, if the user selects an arrow on a horizontal scroll bar, the information will be moved horizontally by some determined amount.

It will be understood that in an alternative embodiment of the present invention, a new scroll bar may be employed. In addition to the standard arrows of a standard scroll bar, this alternative scroll bar may employ other navigable objects, such as page up and page down buttons, which when selected would navigate to and highlight the object at the top or bottom of the page; frame up and frame down buttons, which when selected would navigate to and highlight an object in the frame above or below the frame containing the currently highlighted object; and frame right and frame left buttons, which when selected would navigate to and highlight an object in the frame to the right or to the left, respectively, of the frame containing the currently highlighted objected. It will also be understood that additional keys may be added to the keyboard 28 or the remote control device 30 which permit navigation in the above manners.

As often is encountered with web pages, some frames of information contain ghosted objects, such that the application to which the object is associated is not available at that particular time. Ghosted objects are well known in the art and need not be explained in detail herein. For example, the “Back” button on the first web page of an Internet session may be a ghosted button because there does not exist a previous web page for the user to go “Back” to view. As an additional example, an up arrow key on a scroll bar may be ghosted when the user is at the top of the text associated with the scroll bar. In the preferred embodiment of the present invention, ghosted objects cannot be navigated to or highlighted.

As is well known, objects may also become ghosted while the object is currently selected or highlighted. Preferably, the processing controller 22 continues to highlight an object which becomes ghosted while highlighted or selected so the user is permitted to navigate from the ghosted object. Once a user navigates from a ghosted object, however, a user will not be permitted to navigate back to the ghosted object. Alternatively, the highlight can be moved to the nearest navigable object.

As is well known, navigable objects may contain or require the input of text information, such as on-line order information or text contained in a large document. With respect to objects that include or require a line or multiple lines of text input, the preferred embodiment of the present invention highlights the entire object, as previously described. Preferably, the user may select the object by pressing the appropriate select button or by simply typing information that is to be inserted in the box. Once the box is selected in either manner, a cursor appears and the user may navigate through the box by utilizing the directional keys, or if inserting information, simply typing. In the event a user navigates to a text object using a television remote control, preferably a pop-up keyboard is displayed to permit the user to input the appropriate information. The use of pop-up keyboards is well known in the art and need not be described in detail herein.

A user may navigate through the text contained in an object by pressing the right or left arrow keys to navigate in the corresponding direction. Preferably, in an object containing or requiring multiple lines of text, the pressing of these keys allow the cursor to automatically wrap around to the next line when the cursor moves to the end of the current line. Auto-wrapping is well known in the art and need not be explained in detail herein. Similarly, the up and down arrow keys may also be employed to move the cursor line-by-line in the designated direction in a multiple line text object.

In an object containing text, the user may exit the object and navigate to a closely located object by pressing the appropriate key when the cursor is at the top or bottom of the text information. For example, if the cursor is at the top of the text information, the user may press the up arrow key to exit the text information object and navigate to another navigable object located above the current object. Similarly, if the cursor is located at the bottom of the text information, the user may navigate to a navigable object below the text object by pressing the down arrow key. It should be obvious that by pressing the up or down arrow key in a single line text object, the processing controller 22 will navigate to an object in the indicated direction, in a similar fashion as described.

Web pages also contain what are known as drop down boxes, which allow a user to select one or more items from a list of predetermined information. For example, a drop down box containing a list of the fifty states may be employed when providing an address. Drop down boxes may also be employed where gender information or marital status is required. Drop down boxes may also allow the user the option of typing in the required information. Drop down boxes which provide a user the option of either selecting from a list or typing information will be referred to herein as a “drop down combination”.

Preferably, when a drop down box is navigated to and highlighted, the user may select the box by pressing the appropriate select key, as previously discussed. Where a drop down combination is employed, the user may also select the object by simply typing information, as was previously discussed. Once the drop down box or drop down combination is selected, the listed information may be navigated by pressing the up or down arrow key, as appropriate. If a scroll bar is employed as part of the drop down box, it is preferable that pressing the right arrow key will activate the scroll bar, as previously discussed. The user will then be allowed to navigate through the listed information contained in the drop down box using the scroll bar, as discussed above.

Web pages also may contain server side image maps, which contain navigable objects within a larger navigable object. When a user navigates to a server side image map object and selects the object, a cursor type image is created which indicates the current position of the cursor type image within the navigable object. The user may navigate the cursor by pressing the directional arrow keys to the various other navigable objects. As the cursor type image crosses a navigable object within the larger navigable object, the object is highlighted. The object may be activated by pressing the appropriate select key, as previously discussed.

The objects located on the various edges of the server side image map object contain indication means, such as flags, to indicate that the particular object is an edge object. The flags work in a similar manner the “edge of frame” indicators previously discussed. When a directional arrow key associated with the edge indicator is pressed, the edge indicators contain “speed bumps” which may require successive pressing of the arrow key to navigate out of the server side image map object. The processing controller 22 will then navigate to and highlight the closest next navigable object in the appropriate direction.

It should be understood that the present invention may work in conjunction with other devices, such as a pointer device or a mouse type device. When a mouse type device is employed and is pointed at a particular object which is highlighted, a user may also implement the present invention to navigate from the current object. When this occurs, the mouse coordinates warp with the highlighted box, such that the present invention recognizes the object highlighted by the pointer, and begins its navigation from that object. Moreover, the pointer, commonly an arrow, associated with the pointer device does not disappear when the user employs the present invention. Rather, the pointer remains displayed on the screen. Where the pointer is not highlighting any object and the user employs the present system, navigation in the present invention occurs from location of the mouse coordinates, not necessarily from the last highlighted object. In this manner, the system navigates from the pointer to the next object in the direction of the pressed arrow key, and highlights that object, as previously discussed.

Although the invention has been disclosed in terms of a number of embodiments, it will be understood that numerous variations and modifications could be made thereto without departing from the scope of the invention as set forth in the following claims. For example, although the preferred embodiments are directed specifically to an interactive television system, the invention can obviously be applied to any computer system, such as a network or a personal computer. It will further be understood that the present invention is not limited to navigating through web pages. Rather the present invention may be employed to navigate through any displayed information, such as a program guide, VOD order page, a pay per view page and the like.

1. A system for navigating video images and selecting one or more objects in said images comprising:
a) a video image generator for generating one or more video images to be navigated, each said video image including at least one object that can be navigated to and selected; and
b) a mapping application interfaced to said image generator for receiving navigation commands from an input device and instructing said video image generator to navigate to one or more of said objects, said mapping application including linking information identifying which of said objects is to be navigated to based upon a presently selected object and a received navigation command.

2. The system of claim 1, wherein said video image generator is an Internet browser application for generating Internet web pages.

3. The system of claim 1, wherein said video images include a plurality of frames, each containing one or more objects, and said mapping application generates an edge of frame indication for a selected object if it is adjacent one or more edges of a frame, and employs said edge of frame indication in conjunction with a command received from an input device to link said selected object to an object in an adjacent frame that is nearest said selected object in a direction that is dependent on the received command.

4. The system of claim 1, wherein said mapping application links a first object located in a first area of a first of said images with a second object located in a second area of a second of said images, said first and second areas being located in the same general location of said first and second images, respectively.

5. The system of claim 1, further comprising a navigation application interfaced to said image generator and said mapping application for receiving navigation and selection commands from a keyboard type input device, and sending said commands to said image generator, said navigation application being programmed to convert a switch actuation input from an input device into a mouse cursor movement control command upon receipt of a conversion request command from an input device, and send said mouse cursor movement control command to said image generator.

6. The system of claim 5, wherein said navigation application is programmed to convert a switch actuation input from an input device into a mouse cursor movement control command upon detection that a switch on an input device has been pressed for a predetermined period of time.

7. The system of claim 5, further comprising:
a network headend, said headend containing said image generator and said mapping application;
a terminal device interfaced to said headend with a one or more transmission links, said terminal device containing said navigation application; and
an input device interfaced to each of said terminal device for sending navigation and selection command to said navigation application.

8. The system of claim 1, further comprising:
a network headend, said headend containing said image generator and said mapping application;
a terminal device interfaced to said headend with a one or more transmission links; and
an input device interfaced to each of said terminal device for sending navigation and selection commands through said terminal device and said transmission links to said image generator.

9. A system for navigating video images and selecting one or more objects in said images comprising:
a) a video image generator for generating one or more video images to be navigated, each said video image including at least one object that can be navigated to and selected; and
b) a navigation application interfaced to said image generator for receiving navigation and selection commands from a keyboard type input device, and sending said commands to said image generator, said navigation application being programmed to convert a switch actuation input from an input device into a mouse cursor movement control command upon receipt of a conversion request command from an input device, and send said mouse cursor movement control command to said image generator.

10. The system of claim 9, wherein said video image generator is an Internet browser application for generating Internet web pages.

11. The system of claim 9, further comprising a mapping application interfaced to said image generator for receiving navigation commands from an input device and instructing said video image generator to navigate to one or more of said objects.

12. The system of claim 11, wherein said video images include a plurality of frames, each containing one or more objects, and said mapping application generates an edge of frame indication for a selected object if it is adjacent one or more edges of a frame, and employs said edge of frame indication in conjunction with a command received from an input device to link said selected object to an object in an adjacent frame that is nearest said selected object in a direction that is dependent on the received command.

13. The system of claim 11, wherein said mapping application links a first object located in a first area of a first of said images with a second object located in a second area of a second of said images, said first and second areas being located in the same general location of said first and second images, respectively.

14. The system of claim 11, further comprising:
a network headend, said headend containing said image generator and said mapping application;
a terminal device interfaced to said headend with a one or more transmission links, said terminal device containing said navigation application; and
an input device interfaced to each of said terminal device for sending navigation and selection command to said navigation application.

15. The system of claim 9, wherein said navigation application is programmed to convert a switch actuation input from an input device into a mouse cursor movement control command upon detection that a switch on an input device has been pressed for a predetermined period of time.
